(19) United States
(12) Patent Application Publication
(10) Pub. No.: US 2010/0011041 A1
(43) Pub. Date: Jan. 14, 2010

(54) Device and method for determining signals

(76) Inventor: James Vannucci, Mc Donald, PA (US)

Correspondence Address: James Vannucci, 5212 Forest View Drive, Mc Donald, PA, 15057, US

(21) Appl. No.: 12/459,596

(22) Filed: Jul. 6, 2009

Related U.S. Application Data
(63) Continuation-in-part of application No. 12/453,092, filed on Apr. 29, 2009.
Application No. 12/453,092 is a continuation-in-part of application No. 12/218,052, filed on Jul. 11, 2008.
Application No. 12/218,052 is a continuation-in-part of application No. 12/453,078, filed on Apr. 29, 2009.

(51) Int. Cl. G06F 17/14; G06F 7/38

(52) U.S. Cl. 708/400; 708/446; 708/607

(57) ABSTRACT

Many signal processing devices require the solution to a system of equations with a Toeplitz, or block Toeplitz, coefficient matrix. This solution can be obtained with increased efficiency by separating the initial system of equations into a number of systems of equations with reduced dimensions. The solution to the initial system of equations is then calculated from the solutions to the systems of equations with reduced dimensions.

### CROSS-REFERENCE TO RELATED APPLICATIONS

This application is a Continuation in Part of U.S. Ser. No. 12/453,092, filed on Apr. 29, 2009, which is a Continuation in Part of U.S. Ser. No. 12/218,052, filed on Jul. 11, 2008, and a Continuation in Part of U.S. Ser. No. 12/453,078 filed on Apr. 29, 2009, all of which are incorporated herein.

### STATEMENT REGARDING FEDERALLY SPONSORED RESEARCH OR DEVELOPMENT

Not applicable.

### REFERENCE TO A COMPUTER PROGRAM LISTING COMPACT DISC APPENDIX

Not applicable.

### BACKGROUND OF THE INVENTION

The present invention concerns a device and methods for determining signals. Many devices, including imaging, sensing, control, communications, and general signal processing devices determine signals for their operation. General signal processing devices include digital filtering devices, linear prediction devices, system identification devices, and speech and image processing devices. The disclosed device can be a component in these signal processing devices.

Communications devices typically input, process and output signals that represent transmitted data, speech or image information. The devices can be used for communications channel estimation, mitigating intersymbol interference, cancellation of echo and noise, channel equalization, and user detection. The devices can use digital forms of the input signals to generate a covariance matrix and a crosscorrelation vector for a system of equations that must be solved to determine signal weights. The signal weights are usually used to determine signals for the operation of the device. The covariance matrix may be Toeplitz, block Toeplitz, or approximately Toeplitz or block Toeplitz. The performance of a communications device is usually directly related to the maximum dimensions of the system of equations, and the speed at which the system of equations can be solved. The larger the dimensions of the system of equations, the more information can be contained in the weight vector. The faster the system of equations can be solved, the greater the possible capacity of the device.

Sensing devices, including radar, ladar and sonar systems, typically collect energy at a sensor array, and processes the signals that have been generated by the collected energy to obtain coefficients that can be used for beamforming and other applications. The signals can represent physical properties of a target including reflectivity, velocity, shape, and position. Obtaining the coefficients can require determining the solution of a system of equations with a Toeplitz or block Toeplitz coefficient matrix if the sensor array has equally spaced elements. The performance of the sensing device is usually related to the maximum dimensions of the system of equations, since the dimensions usually determine the sensor array size and the resolution of the device. The performance of the sensing device also depends on the speed at which the system of equations can be solved. Increasing the solution speed can improve tracking of the target, or determining the position of the target in real time. Larger sensor arrays also result in a much narrower beam for resistance to unwanted signals.

Imaging devices, including synthetic aperture radar, fault inspection devices, LIDAR, geological imaging devices, and medical imaging devices including magnetic resonance imaging (MRI), computed tomography (CT), positrom emission tomography (PET), and ultrasound devices, require the solution of a system of equations with a Toeplitz or block Toeplitz coefficient matrix. The solution is a digital signal that represents an image of biological materials, or non-biological materials. The performance of the imaging device is usually related to the maximum dimensions of the system of equations, since the dimensions usually determine the number of sensor elements and the resolution of the device. Device performance is also improved by increasing the speed at which the system of equations can be solved, since this can facilitate real time operation.

Control devices include devices for the control of mechanical, biological, chemical and electrical components. These devices typically process signals that represent a wide range of physical quantities, including deformation, position, temperature, and velocity of a controlled object. The signals are used to generate a Toeplitz or block Toeplitz covariance matrix and a known vector in a system of equations that must be solved for signal weights that are required for controlling the controlled object. The performance of the device is usually directly related to the speed at which the system of equations can be solved, since this improves the response time required to control the controlled object.

General signal processing devices input, process, and output signals that represent a wide range of physical quantities including, but not limited to, signals that represent images, speech, data, transmitted data, and compressed data, and biological and non-biological targets. The output signal can be the solution, or determined from the solution, to a system of equations with a Toeplitz or block Toeplitz coefficient matrix. The performance of the general signal processing device is dependent on the dimensions of the system of equations, and the speed at which the system of equations can be solved.

The performance of the above mentioned devices is usually determined by the efficiency with which a system of equations with a Toeplitz, or block Toeplitz, coefficient matrix is solved. The prior art solution methods for a system of equations with a block Toeplitz coefficient matrix include iterative methods and direct methods. Iterative methods include methods from the conjugate gradient family of methods. Direct methods include Gauss elimination, and decomposition methods including Cholesky, LDU, eigenvalue, singular value, and QR decomposition. Direct methods obtain a solution in O(n³) flops.

Prior art solution methods exist for solving a system of equations with a Toeplitz coefficient matrix. These methods are extensively documented, so they will only be very briefly summarized here. These methods can generally be classified as being either direct or iterative methods, with the direct methods being further classified as classical, fast or super fast, depending on the number of steps required for a solution of the system of equations. The most popular iterative methods include methods from the conjugate gradient family of methods. Classical methods require O(n³) flops and include Gauss elimination and decomposition methods including eigenvalue, singular-value, LDU, QR, and Cholesky decomposition. The classical methods do not exploit the displacement structure of the matrices. Fast methods exploit the displacement structure of matrices and require O(n²) flops. Examples of fast methods include the Levinson type methods, and the Schur type methods. Super-fast methods are relatively new, and require O(n log²n) flops. Iterative methods can be stable, but can also be slow to converge for some systems. The classical methods are stable, but are slow. The fast methods are stable, and can be faster than the iterative methods. The super-fast methods have not been shown to be stable, and many are only asymptotically super-fast.

The following devices require the solution of a system of equations with a block Toeplitz, or Toeplitz, coefficient matrix for their operation. Sensing devices including radar, ladar and sonar devices as disclosed in Zrnic (U.S. Pat. No. 6,448,923), Barnard (U.S. Pat. No. 6,545,639), Davis (U.S. Pat. No. 6,091,361), Pillai (2006/0114148), Yu (U.S. Pat. No. 6,567,034), Vasilis (U.S. Pat. No. 6,044,336), Garren (U.S. Pat. No. 6,646,593), Dzakula (U.S. Pat. No. 6,438,204), Sitton et al. (U.S. Pat. No. 6,038,197), and Davis et al. (2006/0020401). Communications devices including echo cancellers, equalizers and devices for channel estimation, carrier frequency correction, mitigating intersymbol interference, and user detection as disclosed in Kung et al. (2003/0048861), Wu et al. (2007/0133814), Vollmer et al. (U.S. Pat. No. 6,064,689), Kim et al. (2004/0141480), Misra et al. (2005/0281214), Shamsunder (2006/0018398), and Reznik et al. (2006/0034398). Imaging devices including MRI, CT, PET and ultrasound devices as disclosed in Johnson et al. (U.S. Pat. No. 6,005,916), Chang et al. (2008/0107319), Zakhor et al. (U.S. Pat. No. 4,982,162), and Liu (U.S. Pat. No. 6,043,652). General signal processing devices including noise and vibration controllers as disclosed in Preuss (U.S. Pat. No. 6,487,524), antenna beam forming systems as disclosed in Wu et al. (2006/0040706), and Kim et al. (2005/0271016), and image restorers as disclosed in Trimeche et al. (2006/0013479).

The prior art methods that are used to solve systems of equations in the above-indicated devices result in communications devices that have lower capacity, sensing and imaging devices with lower resolution and poor real time performance, control devices with slower response times, and general signal processing devices with lower performance. Devices using the prior art methods often require the coefficient matrix to be regularized, and often have large power and heat dissipation requirements. The methods disclosed herein solve these and other problems by solving the systems of equations with a Toeplitz, or a block Toeplitz, coefficient matrix in the above-indicated devices with large increases in solution efficiency over the prior art methods. The increases in solution efficiency result in improved real time signal processing performance, increased capacity, improved tracking ability, and improved response times in the above devices. The disclosed methods can also solve systems of equations with substantially larger dimensions than the methods in the prior art. This results in the above devices having larger sensor arrays for improved resolution, and the devices being able to process larger amounts of past information. Regularization is usually not required with the disclosed methods because the coefficient matrix is altered in a manner that reduces the condition number of the coefficient matrix. This reduces image distortion in the above devices that would usually be introduced by regularization methods. The power consumption, and heat dissipation, requirements of the above devices are also reduced as a result of the large decrease in processing steps required by the disclosed methods. The disclosed methods also require less computer memory than the prior art methods. The methods can also be implemented on less costly computer hardware.

### BRIEF SUMMARY OF THE INVENTION

The performance of many signal processing devices is determined by the efficiency with which the devices can solve a system of equations with a Toeplitz or block Toeplitz coefficient matrix. This solution can be obtained with increased efficiency if the dimensions of the coefficient matrix and the system of equations are reduced. The disclosed device and method reduce the dimensions of a system of equations and its coefficient matrix. After the dimensions of the systems of equations are reduced, any methods known in the art can be used to obtain the solution to the systems of equations of reduced dimensions with increased efficiency.

The solution to the system of equations with a Toeplitz or block Toeplitz coefficient matrix can also be obtained with increased efficiency if the Toeplitz coefficient matrix is, or the sub-blocks of a block Toeplitz coefficient matrix are, altered by increasing their dimensions, modified by adding rows and columns, approximated, and then transformed. The transformed matrix has, or the transformed sub-blocks have, a narrow-banded form. The rows and columns of the system of equations are then rearranged to obtain a coefficient matrix with a single narrow band. The system of equations with the single narrow-banded coefficient matrix is then solved. The solution to the original system of equations is then obtained from this solution by iterative methods. Additional unknowns are introduced into the system of equations when the dimensions of the system of equations are increased, and when the matrices are modified. These unknowns can be determined by a number of different methods.

The solution to a system of equations with a Toeplitz or block Toeplitz coefficient matrix can be obtained by expanding the Toeplitz matrix, or the sub-blocks of the block Toeplitz matrix, to a circulant form. This expansion requires the addition of unknowns to the system of equations. If the initial system of equations is properly factored into a specific form, the original unknowns, and the additional unknowns can be efficiently determined.

Devices that require the solution of a system of equations with a block Toeplitz, or Toeplitz, coefficient matrix can use the disclosed methods, and achieve very significant increases in performance. The disclosed methods have parameters that can be selected to give the optimum implementation of the methods depending on the particular device.

### DRAWINGS

FIG. 1 shows the disclosed device as a component in a signal processing device.

FIGS. 2(a), 2(b) and 2(c) show the sub-components for different embodiments of the disclosed device and methods.

### DETAILED DESCRIPTION

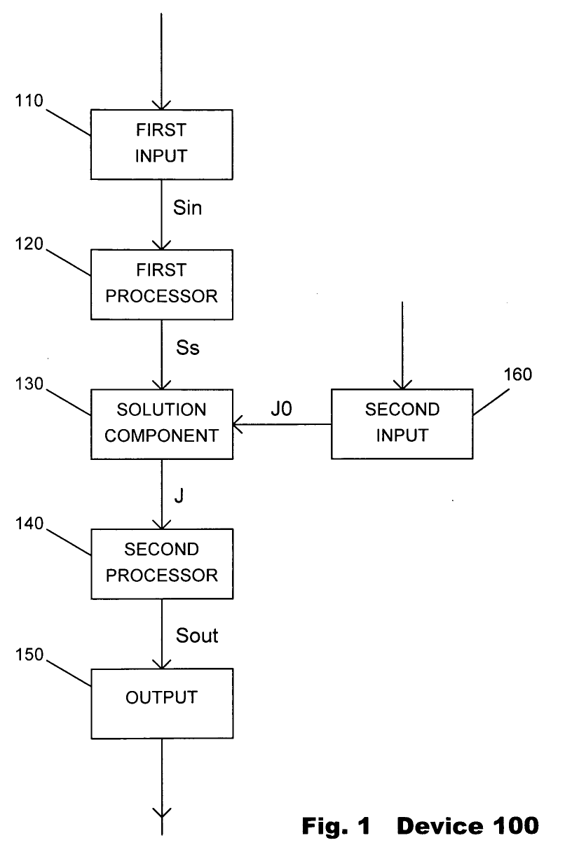

FIG. 1 is a non-limiting example of a signal processing device 100 that comprises a solution component 130 that determines signals J. A first input 110 is the source for at least one signal Sin that is processed at a first processor 120 that forms elements of a block Toeplitz, or Toeplitz, coefficient matrix T₀, and a vector Y₀, from the signals Sin. Signals Ss comprising elements of the matrix T₀ and the vector Y₀ are input to the solution component 130. A system of equations is formed and solved for the solution X by the solution component 130 disclosed in this application. The solution component 130 can processes signals J₀ from a second input 160 with the solution X. The output from the solution component 130 are signals J that are processed by a second processor 140 to form signals Sout for the output 150. Many devices do not have all of these components. Many devices have additional components. Devices can have feedback between components, including feedback from the second processor 140 to the first processor 120, or to the solution component 130. The signals from the second input 160 can be one or more of the signals Sin from the first input 110. The solution component 130 can output the solution X as the signals J without processing signals J₀. In this case, the second processor 140 can processes signals J₀ with the signals J, if required. The device 100 can be a communications device, a sensing device, an image device, a control device, or any general signal processing device known in the art. The following devices are non-limiting examples of devices that can be represented by the device 100. Most of the components of these devices are well known in the art.

As a non-limiting example, a sensing device can include active and passive radar, sonar, laser radar, acoustic flow meters, medical, and seismic devices. For these devices, the first input 110 is a sensor or a sensor array. The sensors can be acoustic transducers, optical and electromagnetic sensors. The first processor 120 can include, but is not limited to, a demodulator, decoder, digital filter, down converter, and a sampler. The first processor 120 usually calculates the elements of a coefficient matrix T₀ from a matrix generated from signals Sin that represent sampled aperture data from one or more sensor arrays. The signals Sin and Ss can represent information concerning a physical object, including position, velocity, and the electrical characteristics of the physical object. If the array elements are equally spaced, the covariance matrix can be Hermetian Toeplitz or block Toeplitz. The known vector Y₀ can be a steering vector, a data vector or an arbitrary vector. The solution component 130 solves the system of equations for the signal weights X. The signal weights X can be applied to signals J₀ to form signals J that produce a beam pattern. The signals J and signal weights X can also contain information concerning the physical nature of a target. The signal weights can also be included as part of the signals J. The second processor 140 can further process the signals J to obtain signals Sout for the output 150, which can be a display device for target information, or a sensor array for a radiated signal.

As a non-limiting example, a communications device can include echo cancellers, equalizers, and devices for channel estimation, carrier frequency correction, speech encoding, mitigating intersymbol interference, and user detection. For these devices, the first input 110 usually includes either hardwire connections, or an antenna array. The first processor 120 can include, but is not limited to, an amplifier, a detector, receiver, demodulator, digital filters, and a sampler for processing a transmitted signal Sin. The first processor 120 usually calculates elements of a coefficient matrix T₀ from a covariance matrix generated from one of the input signals Sin. Signals Sin and Ss usually represent transmitted speech, image or data. The covariance matrix can be symmetric and Toeplitz or block Toeplitz. The known vector Y₀ is usually a cross-correlation vector between two of the transmitted signals Sin, also representing speech, image or data. The solution component 130 solves the system of equations for the signal weights X, and combines the signal weights with signals J₀ from the second input 160 to form desired signals J that usually also represent transmitted speech, images and data. The second processor 140 further processes the signals J for the output 150, which can be a hardwire connection, transducer, or display output. The signals from the second input 160 can be the same signals Sin as those from the first input 110.

As a non-limiting example, a control device can include a device that controls mechanical, chemical, biological and electrical components. Elements of a matrix T₀ and the vector Y₀ can be formed by a first processor 120 from signals Sin. Signals Sin and Ss represent a physical state of a controlled object. Signals Sin are usually collected by sensors 110. The solution component 130 calculates a weight vector X that can be used to generate control signals J from signals J₀. The signals J₀ are an input from a second input 160. The signals J are usually sent to an actuator or transducer 150 after further processing by a second processor 140. The physical state of the object can include performance data for a vehicle, medical information, vibration data, flow characteristics of a fluid or gas, measureable quantities of a chemical process, and motion, power, and heat flow data.

As a non-limiting example, an imaging device can include MRI, PET, CT, and ultrasound devices, synthetic aperture radars, fault inspection systems, sonograms, echocardiograms, and devices for acoustic, and geological, imaging. The first input component 110 is usually a sensor, or a sensor array. The sensors can be acoustic transducers, and optical, and electromagnetic, sensors that produce signals Sin from received energy. The first processor 120 can include, but is not limited to, a demodulator, decoder, digital filters, down converter, and a sampler. The first processor 120 can calculate elements of a coefficient matrix T₀ from a covariance matrix generated from signals Sin, or form a coefficient matrix from a known function, such as a Greene's function, whose elements are stored in memory. The covariance matrix can be Hermetian Toeplitz or block Toeplitz. The known vector Y₀ can be formed from a measured signal Sin, a data vector, or an arbitrary constant. Signals Ss comprise image information. The solution component 130 solves the system of equations for the unknown vector X. Vector X contains image information that is further processed by the second processor 140 to form an image Sout for display on an image display device 150. The signals J include the vector X as the output of the solution component 130.

As a non-limiting example of an imaging device, a MRI device, can comprise a first input 110 that includes a scanning system with an MRI scanner. The first processor 120 converts RF signals Sin to k-space data. The solution component 130 perform image reconstruction by transforming k-space data into image space data X by forming and solving a system of equations with a block Toeplitz coefficient matrix. The second processor 140 maps image space data X into optical data, and transforms optical data into signals Sout for the display 150. The matrix T₀ can be a Fourier operator that maps image space data to k-space data. The vector Y₀ is the measured k-space data. The vector X is image space data.

As a non-limiting example of an imaging device, an ultrasound device, can comprise acoustic receivers 110. The first processor 120 can comprise an amplifier, a phase detector, and an analog-to-digital converters. The first processor 120 forms signals Ss by calculating elements of a coefficient matrix T₀ from a Greene's function, and elements of a known vector Y₀ from sensed incident field energy. The solution component 130 calculates signal coefficients X that represent the conductivity and dielectric constant of a target object. The second processor 140 can comprise a transmit multiplexer, scan devices, an oscillator, and an amplifier. The output 150 can comprise acoustic transmitters, displays, printers, and storage.

As a non-limiting example, the device can be an array antenna system that includes an antenna array 110. The first processor 120 can include down-converters, demodulators, and channel selectors. The first processor 120 calculates elements in steering vectors Y₀, and elements in a covariance matrix T₀ formed from antenna aperture signals Sin. A solution component 130 calculates signal weights X, and multiplies signals J₀ for associated antenna elements by the signal weights X to obtain signals J. A second processor 140 further processes the signals J. The output 150 can be an antenna array, transducer, or display. The signals Ss represent transmitted information.

As a non-limiting example, the device 100 can be a filtering device. The first processor 120 calculates elements of the coefficient matrix T₀ and the vector Y₀ by autocorrelation and cross-correlation methods from sampled signals Sin. Signals Sin and Ss represent voice, images and data. The input 110 can be a hardwire connection or sensor. The solver 130 calculates the vector X, which contains filter coefficients that are applied to signals J₀ from the second input 160 to produce desired signals J that represent voice, images and data. The device 100 may also provide feedback to improve the match between a desired signal, and a calculated approximation to the desired signals. The signals J₀ can be one or more of the signals Sin.

As a non-limiting example, the device I 00 can be a device that relies on linear prediction, signal estimation, or data compression methods for its operation. The first processor 120 calculates elements of a coefficient matrix T₀ from an autocorrelation matrix formed from a sampled signal Sin. The vector Y₀ can also be calculated from sampled signals Sin, or the vector can have all zero values except for its first element. Signals Ss represent speech, images and data. The solver 130 calculates the vector X, which usually contains prediction coefficients used to calculate signals J from signals J₀. The signals J represent predicted speech, images or data. The signals J may not be calculated if the vector X is the device output. In this case, the signal J includes the vector X which represents speech, images and data.

As a non-limiting example, the device 100 can be a device that relies on system identification, system modeling, or pattern recognition methods, for its operation. The first processor 120 calculates elements of a coefficient matrix T₀, usually from an autocorrelation matrix formed from a sampled signal Sin generated by the input 110. The elements of a vector Y₀ are usually calculated by a cross-correlation operation from sampled signals Sin generated by the first input 110. Signals Ss represent speech, images, system characteristics, and data. The solver 130 calculates a vector X containing coefficients that represent speech, images, system characteristics, or data. The solver 130 may also generate signals J. The second processor 140 further processes the vector X. This can include comparisons of the vector X with other known vectors. The output 150 can indicate the results of these comparisons.

As a non-limiting example, the device 100 can be a general signal processing device for image processing, and network routing. Elements of the coefficient matrix T₀ can be calculated from a known function. The vector Y₀ can be formed by the first processor 120 from sampled signals Sin generated by the input 110. The signals Sin and Ss can represent images and data. The solver 130 calculates a vector X which can represent an image to be further processed by the second processor 140, and displayed by the output 150.

As a non-limiting example, the device 100 can be an artificial neural network with a Toeplitz synapse matrix. The first processor 120 calculates elements of the coefficient matrix T₀, and the vector Y₀, by autocorrelation and cross-correlation methods from training signals Sin applied to the input 110. The signals Sin and Ss usually represent speech, images and data. The solver 130 calculates the vector X, which contains the synapse weights. The solver 130 applies the synapse weights X to signals J₀ from the second input 160 to form signals J. The signals J can be further processed by the second processor 140. This processing includes applying a nonlinear function to the signals J, resulting in output signals Sout transmitted to a display device 150. The signals J represent speech, images and data processed by the linear portion of the artificial neural network. The signals J₀ represent an input to the device 100.

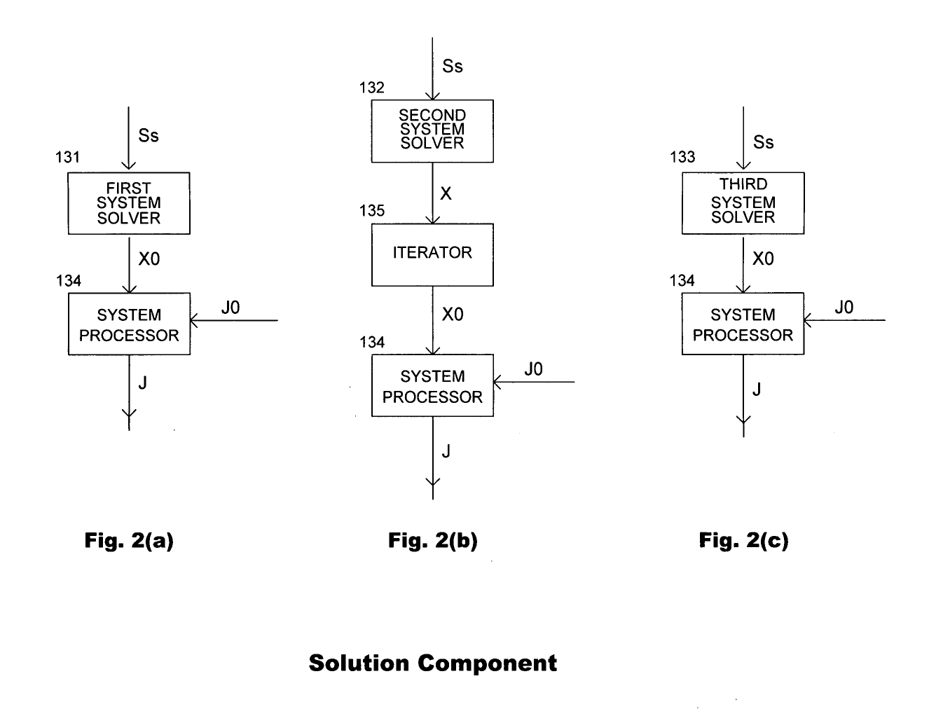

FIGS. 2(a), 2(b), and 2(c) disclose sub-components of a solution component 130 that solves a system of equations (1) with a Toeplitz or block Toeplitz coefficient matrix. The first system solver 131 disclosed in FIG. 2(a) solves equation (1) exactly. The second system solver 132 disclosed in FIG. 2(b) solves a system of equations with a coefficient matrix T that is an approximation to the coefficient matrix of the system of equations (1). The third system solver 133 disclosed in FIG. 2(c) solves equation (1) exactly. If the solution component 130 uses the embodiment of FIG. 2(b), the iterator 135 improves the accuracy of the solution from the second system solver 132. FIGS. 2(a), 2(b), and 2(c) disclose a system processor 134 that forms signals J from the solution X₀. The elements of the coefficient matrix T₀, and the vector Y₀, are input as signals Ss to the solution component 130. The elements of the coefficient matrix T₀, the vectors X, X₀ and Y₀, and the signals J represent physical quantities, as disclosed above.

T₀X₀=Y₀ (1)

In the embodiment of the invention disclosed in FIG. 2(a), the first system solver 131 separates vectors X₀ and Y₀ of equation (1) into symmetric vectors X_{S}(i) and Y_{S}(i) that have elements i equal to elements (N−1−i), and into asymmetric vectors X_{A}(i) and Y_{A}(i), that have elements i equal to the negative of elements (N−1−i). The range of i is 0 to (N/2−1), inclusive. There are N elements in the vectors. The Toeplitz matrix T₀ of equation (1) is separated into a skew-symmetric Toeplitz matrix T_{A}, and a symmetric Toeplitz matrix T_{S}. The original systems of equations can be factored into new systems of equations with symmetric and asymmetric vectors, and coefficient matrices that are either symmetric or skew-symmetric. The redundant elements in the vectors can be eliminated by folding the Toeplitz matrices back on themselves, and either adding or subtracting corresponding elements depending upon whether the vectors are symmetric or asymmetric, respectively. The result is a coefficient matrix that is the sum of a Toeplitz and a Hankel matrix. Half of the rows of this system of equations are redundant, and can be discarded by the first system solver 131. The following relationships can be used to factor the initial system of equations. The product of a symmetric Toeplitz matrix T_{S}, and a symmetric vector X_{S}, is a symmetric vector Y_{S}. The product of a symmetric matrix T_{S}, and an asymmetric vector X_{A}, is an asymmetric vector Y_{A}. The product of a skew-symmetric Toeplitz matrix T_{S}, and a symmetric vector X_{S}, is an asymmetric vector Y_{A}. The product of a skew-symmetric matrix T_{A}, and an asymmetric vector X_{A}, is a symmetric vector Y_{S}.

As a non-limiting example, the system of equations (1) is real, and the coefficient matrix T₀ is symmetric. The vectors are separated into symmetric vectors X_{S} and Y_{S}, and asymmetric vectors X_{A} and Y_{A}. The dimensions of the systems of equations (2) and (3) are then reduced to half by eliminating duplicate elements in the vectors. Two real systems of equations of half dimensions result that are solved by the first system solver 131 by any methods known in the art. If the initial system of equations is complex, and the coefficient matrix is Hermitian Toeplitz, two real systems of equations with the same dimensions as the initial system of equations are formed that are solved by the first system solver 131.

T₀X_{S}=Y_{S} (2)

T₀X_{A}=Y_{A} (3)

As a non-limiting example, the system of equations (1) has a block Toeplitz coefficient matrix and block vectors. The solution can be efficiently obtained by separating each sub-block of the coefficient matrix into symmetric and skew-symmetric sub-blocks, and by separating each sub-vector of the vectors X₀ and Y₀ into symmetric and asymmetric sub-vectors. The terms of the equations are factored to form multiple systems of equations with symmetric and asymmetric sub-vectors. The dimensions of the new systems of equations are then reduced by eliminating duplicate elements in the sub-vectors.

In an embodiment of the invention disclosed in FIG. 2(a), the first system solver 131 separates the sub-vectors of vectors X₀ and Y₀ to form symmetric vectors X_{S} and Y_{S} with symmetric sub-vectors x_{S}(i) and y_{S}(i) that have elements i equal to elements (N−1−i), and asymmetric vectors X_{A} and Y_{A} that have sub-vectors X_{A}(i) and Y_{A}(i), that have elements i equal to the negative of elements (N−1−i). The range of i is 0 to (N/2−1), inclusive. The sub-vectors have N elements. The sub-blocks of the block Toeplitz matrix T₀ are separated into skew-symmetric Toeplitz sub-blocks T_{A}, and symmetric Toeplitz sub-blocks T_{S}. The systems of equations (1) can be factored into systems of equations with vectors having symmetric and asymmetric sub-vectors, and coefficient matrices comprising either symmetric or skew-symmetric sub-blocks. The first system solver 131 usually forms real systems of equations with smaller dimensions. The sub-blocks of the coefficient matrix of these systems of equation are no longer Toeplitz, but instead the sum or difference of a Hankel and a Toeplitz matrix. Each new sub-block is formed by the first system solver 131 folding each Toeplitz sub-block back on itself, and either adding or subtracting corresponding elements depending on whether the sub-vectors are symmetric or asymmetric.

As a non-limiting example, the system of equations (1) has a real Toeplitz block Toeplitz coefficient matrix T₀. The coefficient matrix T₀ has N_{c} symmetric sub-blocks per sub-block row and column. The X₀ and Y₀ vectors have N_{c} sub-vectors. The matrix T₀ has dimensions (N×N), and the sub-blocks of T₀ have dimensions (N_{b}×N_{b}).

$${T}_{0} = \begin{matrix}{T}_{00} & {T}_{01} & {T}_{02} \\ {T}_{01} & {T}_{00} & {T}_{01} \\ {T}_{02} & {T}_{01} & {T}_{00}\end{matrix}$$

The first system solver 131 separates each sub-vector into symmetric and asymmetric sub-vectors. Two systems of equations having the form of equations (2) and (3) result, one having symmetric vectors and the other asymmetric vectors. The sub-vectors of vectors X_{A} and X_{S} have duplicate elements. The dimensions of each of the systems of equations are reduced by folding each of the sub-blocks in half, and either forming a sum or a difference of a Toeplitz matrix, and a Hankel matrix. The lower half of each sub-block is disregarded. This results in two systems of equations (4) and (5) with different coefficient matrices T_{A} and T_{S}, having dimensions (N/2×N/2). If the coefficient matrix is block Toeplitz, these two systems of equations can be solved by the first system solver 131 for X_{S1} and X_{A1}, which are either the upper, or lower, half of the sub-vectors of vectors X_{S} and X_{A}, respectively.

T_{S}X_{S1}=Y_{S} (4)

T_{A}X_{A1}=Y_{A} (5)

If the coefficient matrix T₀ is Toeplitz block Toeplitz, the first system solver 131 rearranges rows and columns in both coefficient matrices T_{A} and T_{S} to obtain two block Toeplitz rearranged matrices. These rearranged matrices have sub-blocks that are Toeplitz with dimensions (N_{c}×N_{c}). The rows of the vectors in equations (4) and (5) are also rearranged. These rearranged vectors are then split into vectors with symmetric sub-vectors, and asymmetric sub-vectors. The sub-blocks in both rearranged matrices can be folded in half, with the resulting elements in each sub-block being either the sum or difference of a Toeplitz and a Hankel matrix. Each sub-block now has dimensions (N_{c}/2×N_{c}/2). There are now four systems of equations. Each system of equations has a different coefficient matrix. The dimensions of each of the four systems of equations are (N/4×N/4). The four systems of equations are solved by the first system solver 131 using any methods known in the art. The four solutions are combined to form the solution X₀ to system of equations (1).

In a nonlimiting example, the matrix T₀ of equation (1) is a complex Hermetian Toeplitz block Toeplitz matrix. The vectors X₀ and Y₀ are complex vectors. The system of equations can be multiplied out to form a real, and an imaginary, set of equations. These two sets of equations can both be further split into sets of equations with vectors that have symmetric and asymmetric sub-vectors. These four sets of equations can be combined into two sets of equations (6) and (7), with the same coefficient matrix having dimensions (2N×2N). The sub-blocks have dimensions (N_{b}×N_{b}). There are 2N_{c} sub-blocks in each row and column. The sub-block T_{SR} is the real symmetric component of the matrix T₀. The sub-block T_{A1} is the imaginary asymmetric component of the matrix T₀. The subscripts R, I, S, and A in equations (6) and (7) designate real, imaginary, symmetric, and asymmetric components, respectively.

$$\begin{matrix}{TX}_{01} = {Y}_{01} \\ T = \begin{matrix}{T}_{SR} & - {T}_{AI} \\ {T}_{AI} & {T}_{SR}\end{matrix} \\ {Y}_{01} = \begin{matrix}{Y}_{RS} \\ {Y}_{IA}\end{matrix} \\ {X}_{01} = \begin{matrix}{X}_{RS} \\ {X}_{IA}\end{matrix} & ( 6 ) \\ {TX}_{02} = {Y}_{02} \\ {Y}_{02} = \begin{matrix}{Y}_{IS} \\ - {Y}_{RA}\end{matrix} \\ {X}_{02} = \begin{matrix}{X}_{IS} \\ - {X}_{RA}\end{matrix} & ( 7 )\end{matrix}$$

Each quadrant of the matrix T has Toeplitz sub-blocks. The block vectors X₀₁, X₀₂, Y₀₁ and Y₀₂ have sub-vectors that contain duplicate elements which can be eliminated by folding each sub-block of the matrix T in half, reducing the dimensions of each sub-block to (N_{b}/2×N_{b}/2), and forming coefficient matrix T₁. If the coefficient matrix T₀ is block Toeplitz, the first system solver 131 solves these two systems of equations with the same coefficient matrix for the elements in the vectors X₀₁ and X₀₂. These vectors are then combined to determine the vector X₀.

For a Toeplitz block Toeplitz coefficient matrix T₀, the rows and columns of the coefficient matrix T₁ can be rearranged within each quadrant to form a block Toeplitz coefficient matrix T₂. The block vectors are also rearranged, and these rearranged block vectors from both systems of equations can be split into symmetric block vectors X_{11S}, X_{12S}, Y_{11S}, and Y_{12S}, and asymmetric block vectors X_{11A}, X_{12A}, Y_{11A} and Y_{12A}, each with duplicated elements. Each sub-block of the matrix T₂ can be folded to half dimensions, eliminating the duplicate vector elements. The result is four systems of equations with two different coefficient matrices T_{2S} and T_{2A}, of dimensions (N/2×N/2). The four systems of equations can each be solved by the first system solver 131 for the elements in the four block vectors X_{11S}, X_{11A}, X_{12S}, and X_{12A}. These vectors are then combined to determine the solution X₀.

In an embodiment of the invention disclosed in FIG. 2(b), the Toeplitz coefficient matrix T₀ of equation (1) can be transformed to a form that is approximately narrow-banded. To decrease the magnitude of the elements outside of the bands of the transformed coefficient matrix, the matrix T₀ can have its diagonals extended to form a matrix T of greater dimensions than the matrix T₀. Extending the diagonals of the matrix T₀ will also introduce additional diagonals with elements of arbitrary values. The arbitrary values can include, but are not limited to, values given by the following relationships (8).

T(j)(N−1−i)=T(1+i)(j) (8)

T(N−1−i)(j)=T(j)(1+i)

The dimensions of matrix T(i)(j) are (N×N). The values for indices i and j include zero to the number of additional diagonals. The relationships apply for elements of the new diagonals, not the new elements of the extended diagonals, which are approximately equal to other elements in the respective diagonal. The vectors X and Y are zero-padded, with zero elements in rows that correspond to the additional pad rows and columns of the matrix T. Additional unknowns Sₚ are introduced to the system of equations. The matrix Aₚ comprises columns with all zero elements except for nonzero elements corresponding to pad rows. The matrix Bₚ comprises pad rows added to the matrix T₀ to form matrix T.

The magnitude of elements outside the bands of a transformed coefficient matrix can also be reduced by modifying rows and columns of the matrix T₀. The matrix B_{q} comprises modifying rows. The matrix A_{q} comprises modifying columns, and columns with all zero elements except for nonzero elements that correspond to modifying rows.

TX=Y+AₚSₚ+A_{q}S_{q} (9)

To determine the values for the matrices Aₚ and A_{q} of equation (9), the matrix T is separated into a sum of matrix products after it has its diagonals extended, but before it may be modified. The sum of matrix products comprises diagonal matrices D₁ᵢ and D₂ᵢ, and circulant matrices Cᵢ. The elements on the diagonals of matrices D₁ᵢ and D₂ᵢ are usually given by exponential functions. A quotient Uᵣᵢ/Lᵣᵢ is approximately substituted for each diagonal matrix Dᵣᵢ. The Fourier transform of the matrices Uᵣᵢ are banded matrices Uᵣᵢₜ. The following summation of equation (10) is over the index i.

$$T = \sum \frac{{U}_{1 i}}{{L}_{1 i}} {C}_{i} \frac{{U}_{2 i}}{{L}_{2 i}} \qquad ( 10 )$$

Each quotient Uᵣᵢ/Lᵣᵢ can be calculated from the element on the principal diagonal of a diagonal matrix Dᵣᵢ, gᵣᵢ(x), by expression (11). The sum is over the index m.

$${g}_{ri} ( x ) ≅ \frac{\sum {A}_{rim} cos ( {w}_{m} x ) + \sum {B}_{rim} sin ( {w}_{m} x )}{\sum {C}_{rim} cos ( {w}_{m} x ) + \sum {D}_{rim} sin ( {w}_{m} x )} \qquad ( 11 )$$

Regression methods, including non-linear regression methods, can be used to determine the weight constants for the expansion functions cosine and sine. Regression methods are well known in the art. The iterative, weighted least-squares method of equation (12) can also be used to determine the weight constants. The gᵣᵢ(x) elements that correspond to pad and modified rows and columns are usually not included in the calculations that determine the weight constants. Once the weight constants have been determined, values for the elements that correspond to pad and modified rows and columns are then calculated. These values are then used in place of the original values in the matrices, and determine the pad and modified rows and columns. The modifying rows and columns are calculated from the difference between g(x) and the summation of equation (11). The outer summation of equation (12) is over index x. The inner summation of equation (12) is over the index m.

Σ(gᵣᵢ(x)(ΣDᵣᵢₘ sin(wₘx)+ΣCᵣᵢₘ cos(wₘx))−ΣBᵣᵢₘ sin(wₘx)+ΣAᵣᵢₘ cos(wₘx))²/Bᵣₚ(x)=err (12)

Here Bᵣₚ(x) is constant for each iteration, and is updated for each iteration based on the values of the constants from the previous iteration. The following summation is over the index m.

Bᵣₚ(x)=ΣDᵣᵢₘ sin(wₘx)+ΣCᵣᵢₘ cos(wₘx)

Equation (9) can be transformed to a system of equations (13) with a transformed coefficient matrix Tₜ that is narrow-banded. The vector Yₜ is calculated by equation (14). The matrices U₁ᵢₜ and U₂ᵢₜ are constant, banded, known matrices that are stored in memory. The matrix (ΠL₁ᵢ) is a diagonal matrix stored in memory. The matrices A_{qt} and Aₚₜ have few columns, and are stored in memory. The matrix [FFT] is a discrete fast Fourier transform matrix. Matrices Cᵢₜ, Uᵣᵢₜ and Lᵣᵢₜ are the FFTs of matrices Cᵢ, Uᵣᵢ and Lᵣᵢ.

TₜXₜ=Yₜ+AₚₜSₚ+A_{qt}S_{q} (13)

Tₜ≅ΣU₁ᵢₜCᵢₜU₂ᵢₜ

Yₜ=[FFT](ΠL₁ᵢ)Y (14)

Aₚₜ=[FFT](ΠL₁ᵢ)Aₚ

A_{qt}=[FFT](ΠL₁ᵢ)A_{q}

Sₚ=BₚX

S_{q}=B_{q}X

(I−B_{q}X_{Aq})S_{q}=B_{q}X_{Y}+B_{q}X_{Ap}Sₚ (15)

(I−BₚX_{Ap})Sₚ=BₚX_{Y}+BₚX_{Aq}S_{q} (16)

The system of equations (13) can be solved by the second system solver 132 of FIG. 2(b) by any means known in the art, including any decomposition methods. Usually, the unknowns Sₚ and S_{q} are determined first by equations (15), (16) or (17), then the unknown X is calculated. If there are no modified rows and columns, the Sₚ values can be calculated from the pad row portion of the vector X_{Y} by equation (17). In general, the second system solver 132 calculates Sₚ and S_{q}, then uses equation (18) to calculate the vector X.

X_{Y}=−X_{Ap}Sₚ (17)

X=X_{Y}+X_{Ap}Sₚ+X_{Aq}S_{q} (18)

If the matrix T is a sufficient approximation to the matrix T₀, the solution X to the system of equations with the matrix T can be used as the solution X₀ to the system of equations with the covariance coefficient matrix T₀. If the solution X is not a sufficient approximation to the solution X₀, the iterator 135 of FIG. 2(b) uses the solution X to calculate the solution X₀ by any methods known in the art. These methods include obtaining an update to the solution by taking the initial solution X, and using it as the solution to the original matrix equation (19). The difference between the Y₀ vector, and the product of the original T₀ matrix and the solution X, is then used as the new input column vector for the matrix equation (20) with the T matrix. The vector Yₐ is approximately equal to the vector Y. The vectors Xᵤ and Yₐ are padded vectors. The vector Sᵤ is an unknown to be determined.

T₀X₀=Y₀ (19)

TX=Y₀+AS

T₀X=Yₐ

TXᵤ=Y₀−Yₐ+ASᵤ (20)

X₀=X+Xᵤ

In an embodiment of the disclosed invention, the second system solver 132 of FIG. 2(b) can add pad rows and columns to, and can modify existing rows and columns of, each sub-block of the block Toeplitz coefficient matrix T₀ in equation (1), to form a coefficient matrix T. The coefficient matrix T can be separated into the sum of a symmetric coefficient matrix T_{S} that has sub-blocks that are all symmetric, and a skew-symmetric coefficient matrix T_{A} that has sub-blocks that are all skew-symmetric. The vectors X₀ and Y₀ in system of equations (1) are block vectors that are separated into the sum of two block vectors, X_{S} and X_{A}, and Y_{S} and Y_{A}, respectively. The sub-vectors of these vectors are zero padded. The symmetric vectors X_{S} and Y_{S} have symmetric sub-vectors, and the skew-vectors X_{A} and Y_{A} have skew-symmetric sub-vectors. Symmetric sub-vectors have elements i equal to elements (N−i). Skew-symmetric sub-vectors have elements i equal to the negative of elements (N−i). The range of i is 1 to (N/2−1). There are N elements in the sub-vector. Elements 0 and N/2 are zero for skew-symmetric sub-vectors, and can have any value for symmetric sub-vectors.

The following relationships can be used to factor a system of equations with a block Toeplitz coefficient matrix. The product of a symmetric Toeplitz sub-block T_{S}, and a symmetric sub-vector X_{S}, is a symmetric sub-vector Y_{S}. The product of a symmetric sub-block T_{S}, and a skew-symmetric sub-vector X_{A}, is a skew-symmetric sub-vector Y_{A}. The product of a skew-symmetric Toeplitz sub-block T_{A}, and a symmetric sub-vector X_{S}, is a skew-symmetric sub-vector Y_{A}. The product of a skew-symmetric sub-block T_{A}, and a skew-symmetric sub-vector X_{A}, is a symmetric sub-vector Y_{S}. The Fourier transform of a symmetric sub-vector is real. The Fourier transform of a skew-symmetric sub-vector is imaginary.

Generally, the second system solver 132 multiplies out, and separates, a complex system of equations into two systems of equations, one for the real, and the other for the imaginary, terms. Each of these systems of equations are further separated into systems of equations with symmetric and skew-symmetric vectors. These four sets of equations are combined to form a real system of equations with dimensions (4N×4N).

In a non-limiting example, the coefficient matrix T₀ is a real Toeplitz block Toeplitz matrix. The second system solver 132 forms two systems of equations (21) and (22) with a real Toeplitz block Toeplitz coefficient matrix T by factoring equation (1). The sub-blocks of matrix T are symmetric with dimensions (N_{b}×N_{b}). Coefficient matrix T has dimensions (N×N). There are N, sub-blocks in each row and column of T₀. Equation (21) comprises symmetric vectors X_{S} and Y_{S}. Equation (22) comprises skew-symmetric vectors X_{A} and Y_{A}. Equations (21) and (22) have the same coefficient matrix T.

The second system solver 132 increases the dimensions of each of the sub-blocks in the coefficient matrix of equation (1) by placing pad rows and columns around each of the sub-blocks. The matrix A results from the matrix T having larger dimensions than the matrix T₀, and from modifications made to rows and columns of the matrix T₀ to form the matrix T. The vectors S contain unknowns to be determined. The matrix A can comprise elements that improve the solution characteristics of the system of equations, including improving the match between the matrices T and T₀, lowering the condition number of the matrix T, and making a transform of the matrix T, matrix Tₜ, real. Matrix A can comprise modifying columns, and columns with all zero values except for one or two nonzero values corresponding to pad and modified rows of matrix T. Matrix B can comprise pad rows, and modifying rows that modify elements in the T₀ matrix. The sub-vectors of vectors X_{S}, X_{A}, Y_{S} and Y_{A} have zero pad elements that correspond to pad rows.

TX_{S}=Y_{S}+AS_{S} (21)

TX_{A}=Y_{A}+AS_{A} (22)

BX_{S}=S_{S}

BX_{A}=S_{A}

Each of the sub-blocks of the coefficient matrix T is separated by the second system solver 132 into a sum of the products of diagonal matrices d₁ᵢ, circulant matrices C_{ixy}, and diagonal matrices d₂ᵢ. The sum is over the index i. The elements in the diagonal matrices d₁ᵢ and d₂ᵢ are given by exponential functions with real and/or imaginary arguments, trigonometric functions, elements that are one for either the lower, or upper, half of the principal diagonal elements, and negative one for the other upper, or lower, half of the principal diagonal elements, elements determined from other elements in the diagonal by recursion relationships, and elements determined by factoring or transforming the matrices containing these elements. For the non-limiting example of a general block Toeplitz matrix, the sub-blocks have the general form of equation (23).

$$T = \begin{matrix}{T}_{00} & {T}_{01} & {T}_{02} \\ {T}_{10} & {T}_{11} & {T}_{12} \\ {T}_{20} & {T}_{21} & {T}_{22}\end{matrix} \qquad ( 23 )$$

The submatrices T_{xy} of equation (23) comprise a product of matrices uᵣᵢ, lᵣᵢ, and C_{ixy}. The following summation is over the index i.

$${T}_{xy} = \sum \frac{{u}_{1 i}}{{l}_{1 i}} {C}_{ixy} \frac{{u}_{2 i}}{{l}_{2 i}}$$

As a non-limiting example, a block coefficient matrix T can be represented by a sum over i that comprises two products. Each sub-block is separated with the same diagonal matrices d and d*, where the Fourier transform of the matrix d is the complex conjugate of the Fourier transform of the matrix d*. This requires the system of equations have at least one pad, or modified, row and column. The block matrix T can be separated as follows. In equation (24), matrices D and Cᵢ are block matrices.

$$\begin{matrix}T = D {C}_{1} {D}^{*} + {D}^{*} {C}_{2} D & ( 24 ) \\ D {C}_{1} {D}^{*} = \vert \begin{matrix}d & & \\ & d & \\ & & d\end{matrix} \vert \vert \begin{matrix}{C}_{100} & {C}_{101} & {C}_{102} \\ {C}_{110} & {C}_{111} & {C}_{112} \\ {C}_{120} & {C}_{121} & {C}_{122}\end{matrix} \vert \vert \begin{matrix}{d}^{*} & & \\ & {d}^{*} & \\ & & {d}^{*}\end{matrix} \vert & ( 25 )\end{matrix}$$

A sub-block comprising the quotient of diagonal matrices u/l or u*/l is approximately substituted for each sub-block d or d*, respectively. The diagonal matrices u and l can be determined by any methods known in the art, including the method of equation (12). The transformed system of equations (26) is formed by transforming each sub-block of the coefficient matrix individually to form a banded sub-block. The matrices T_{L} and T_{R} are block matrices that can comprise fast Fourier transform (FFT) sub-blocks, and inverse fast Fourier transform (iFFT) sub-blocks, that transform a product comprising each of the sub-blocks T_{xy}. The matrix product (ΠLᵣᵢ) is a block matrix with sub-blocks that comprise a product of the matrices lᵣᵢ. The matrices T_{L}, T_{R} and (ΠLᵣᵢ) usually only have nonzero blocks on the principal diagonals. In a non-limiting example, the matrix Tₜ can be efficiently calculated from equation (27). The matrices Cᵢₜ are block matrices with each sub-block being a diagonal matrix. Each sub-block is the FFT of a corresponding circulant sub-block of a matrix Cᵢ, determined from equation (24). The matrices Uᵣᵢₜ and Lᵣᵢₜ are block matrices with the only nonzero sub-blocks being the sub-blocks on their principal diagonals. The nonzero sub-blocks of the matrix Uᵣᵢₜ are identical narrow-banded sub-blocks. The non-zero sub-blocks of Lᵣᵢₜ are identical. The nonzero sub-blocks of the matrices Uᵣᵢₜ and Lᵣᵢₜ are the Fourier transforms of the nonzero sub-blocks of the matrices Uᵣᵢ and Lᵣᵢ, respectively. The matrices Uᵣᵢ and Lᵣᵢ have all sub-blocks equal to zero, except for diagonal sub-blocks on their principal diagonals. Matrices Uᵣᵢₜ and Lᵣᵢₜ are usually stored in memory. If all the matrices Lᵣᵢ are equal, the term (ΠLᵣᵢ) is a single matrix L. Only two matrices Uᵣᵢₜ may be required as disclosed in equation (27). The nonzero sub-blocks of the matrices Uᵣᵢₜ comprise corner bands in the upper right, and lower left, corners of the matrix. These corner bands result in corner bands for the sub-blocks of the matrix Tₜ. The corner bands of the sub-blocks of the matrix Tₜ can be combined with the band around the principal diagonal of the sub-blocks of the matrix Tₜ when the sub-blocks of the matrix Tₜ are folded to reduced dimensions.

TₜXₜ=Yₜ+AₜS (26)

Tₜ=T_{L}(ΠL₁ᵢ)T(ΠL₂ᵢ)T_{R}

Tₜ=UₜC₁ₜUₜ*+Uₜ*C₂ₜUₜ (27)

Aₜ=T_{L}(ΠL₁ᵢ)A

Yₜ=T_{L}(ΠL₁ᵢ)Y

Xₜ=T_{R}(Πinv L₂ᵢ)X

After equations (21) and (22) have been transformed, each transformed sub-block of the coefficient matrix can be folded to dimensions (N_{b}/2+1)×(N_{b}/2+1) to eliminate duplicate elements of the transformed sub-vectors of the transformed vectors. The result is two real systems of equations with coefficient matrices whose rows and columns can be rearranged to form coefficient matrices T_{A} and T_{S} that have dimensions of N_{c}(N_{b}/2+1)×N_{c}(N_{b}/2+1). If the coefficient matrix T₀ is block Toeplitz, the rows and columns of the coefficient matrices T_{A} and T_{S} form banded coefficient matrices in a system of equations that can be solved by the second system solver 132.

If the coefficient matrix T₀ is Toeplitz block Toeplitz, the coefficient matrices T_{A} and T_{S} have bands that comprise Toeplitz sub-blocks. These Toeplitz sub-blocks can be padded and modified to form matrices T_{1S} and T_{1A}. The vectors X_{1S}, X_{1A}, Y_{1S}, and Y_{1A}, and the matrices A_{1S} and A_{1A}, are formed when the coefficient matrices T_{1S} and T_{1A} are formed. The vectors S contain additional unknowns. Matrices A_{1S}, A_{1A}, B_{1S} and B_{1A} are the matrices A_{S}, A_{A}, B_{S} and B_{A}, respectively, further comprising modifying rows and columns that were used to modify elements in the T_{S} and T_{A} matrices, and columns with nonzero elements that correspond to pad rows used to increase the dimensions of the matrices T_{S} and T_{A}. Vectors X_{1S}, X_{1A}, Y_{1S} and Y_{1A} have zero pad elements that were added to their rows that correspond to rows that were used to increase the dimensions of the sub-blocks of the coefficient matrices T_{S} and T_{A}.

Each system of equations is then factored into two systems of equations, one for symmetric, and the other for skew-symmetric vectors. The second system solver 132 transforms each sub-block in the padded/modified matrices T_{1S} and T_{1A}. Each system of equations is transformed by the matrices T_{R}, T_{L} and Lᵣᵢ disclosed in equation (26). Each sub-block is then folded, and reduced to dimensions (N_{c}/2+1)×(N_{c}/2+1). A different single banded, transformed coefficient matrix, T_{2SS}, T_{2SA}, T_{2AS} and T_{2AA}, is formed for each of the four systems of equations that have dimensions (N_{c}/2+1)(N_{b}/2+1)×(N_{c}/2+1)(N_{b}/2+1). The second system solver 132 solves the four systems of equations to obtain equations of the form of equation (31). The solutions to the four systems of equations are combined to form a solution X.

In a non-limiting example, the system of equations (1) has a complex Hermetian Toeplitz block Toeplitz coefficient matrix T₀, and complex vectors X₀ and Y₀. The system of equations (1) can be factored into two systems of equations (6) and (7). The second system solver 132 can pad, separate, and modify each sub-block of the matrix T of equations (6) and (7) to obtain the matrix T of equations (28) and (29).

$$\begin{matrix}{TX}_{01} = {Y}_{01} + {A}_{01} {S}_{01} \\ {A}_{01} = \begin{matrix}{A}_{RS} \\ {A}_{IA}\end{matrix} & ( 28 ) \\ {TX}_{02} = {Y}_{02} + {A}_{02} {S}_{02} \\ {A}_{02} = \begin{matrix}{A}_{IS} \\ - {A}_{RA}\end{matrix} & ( 29 )\end{matrix}$$

Each sub-block of the matrix T of equations (28) and (29) can then be transformed to a banded sub-block by matrices T_{R}, T_{L} and Lᵣᵢ as disclosed in equation (26). The sub-vectors are also transformed, and each transformed sub-vector contains duplicate elements that can be eliminated by folding each sub-block of the matrix T back on itself. If the coefficient matrix T₀ is block Toeplitz, the rows and columns of the two coefficient matrices can be rearranged to a banded form, and the two systems of equations solved by the second system solver 132 after being reduced in dimensions. Both systems of equations have the same coefficient matrix T₁ before the rows and columns are rearranged.

If the coefficient matrix T₀ is Toeplitz block Toeplitz, the rows and columns within each quadrant of T₁ can be rearranged within each quadrant to form a coefficient matrix with bands in each quadrant that comprise Toeplitz sub-blocks. The second system solver 132 adds pad and/or modified rows and columns to each Toeplitz sub-block, and then transforms each sub-block to a banded form. Since the transformed sub-blocks are real, the sub-vectors of the transformed vectors can be split into symmetric and skew-symmetric sub-vectors with duplicated elements. Each sub-block can be folded back on itself to eliminate the duplicate elements in each of the sub-vectors. Four systems of equations result with two different coefficient matrices of dimensions 2(N_{c}/2+1)(N_{b}/2+1)×2(N_{c}/2+1)(N_{b}/2+1). The second system solver 132 solves the four systems of equations to obtain four systems of equations of the form of equation (31). The four solution vectors are combined to obtain the solution X.

In an embodiment of the invention disclosed in FIG. 2(c), a symmetric or skew-symmetric Toeplitz coefficient matrix in a real system of equations with vectors that are either symmetric or skew-symmetric, as defined above, can be expanded to a circulant matrix C with the addition of N/2 unknown elements contained in a vector S. The same method can also be applied to a system of equations with vectors that are either symmetric or asymmetric vectors, as defined above. A circulant matrix, C, is a type of Toeplitz matrix that is diagonalized by a Fourier transform. Equation (8) can determine the new diagonal elements of C. The third system solver 133 of FIG. 2(c) calculates the vectors S and X of equation (30) by any methods known in the art, including methods that apply a Fourier transform to the system of equations. These calculations have complexity of O (N/2)³ flops. The dimensions of the initial system of equations are (N×N). The dimensions of the system of equations (30) and the matrix C are approximately (2N×2N). The vectors X and Y have zero pad elements, usually at the beginning and end of the vectors, that correspond to pad rows and columns used to create the circulant matrix C from the Toeplitz matrix.

CX=Y+AS (30)

For a complex system of equations, the vector S can include as many as 2N unknowns. The original system of equations is usually not in the proper form for the application of this method. For these cases, the system of equations can be factored as disclosed above into a form with symmetric and asymmetric, or skew-symmetric and symmetric vectors, and symmetric and skew-symmetric Toeplitz matrices. Once the vectors and coefficient matrices are in this form, the method can be applied. While the method is not computationally efficient for all matrices, it is computationally efficient for some matrices.

In a non-limiting example, a system of equations with a block Toeplitz coefficient matrix that has either symmetric or skew-symmetric sub-blocks, and vectors that have sub-vectors that are either symmetric or asymmetric, as defined above, or that have sub-vectors that are either symmetric or skew-symmetric, as defined above, can have its dimensions increased such that a block circulant coefficient matrix is formed from the block Toeplitz coefficient matrix. This requires that pad rows and columns be added to the system of equations, usually surrounding each sub-block. The dimensions of the system of equations are usually doubled, or approximately doubled, with the introduction of approximately N/2 additional unknowns to the system of equations. If the dimensions of the initial system of equations are (N×N), the matrix A usually includes N/2 columns with all zero values except for one or two nonzero elements in each column. The columns usually have 2N elements. To determine the values of S, a system of equations usually with dimensions (N/2×N/2) must be solved. The circulant sub-blocks can be Fourier transformed to diagonal sub-blocks. The rows and columns of the coefficient matrix are rearranged to form a coefficient matrix with nonzero sub-blocks only on the principal diagonal. This system of equations is solved by the third system solver 133 to obtain an equation of the form of equation (31). Equation (32) can be used to determine the vector S. Equation (32) is formed from pad rows of equation (31). These rows have zero values for the vector Y. Equation (31) can be used to calculate the vector X once the vector S is known.

In a non-limiting example, the initial system of equations has a real symmetric or complex Hermitian Toeplitz block Toeplitz coefficient matrix. Either of the above methods can be used by the third system solver 133 to form systems of equations with coefficient matrices having symmetric sub-blocks, and vectors with sub-vectors that are either symmetric or asymmetric, or symmetric or skew-symmetric, depending on the method. Each sub-block of the coefficient matrix is expanded to a circulant form. The expanded system of equations is transformed, rearranged, and solved for vectors S and X.

Once the systems of equations are placed in a form with a circulant, or banded coefficient matrix, or a form with reduced dimensions, they can be solved by any methods known in the art. These methods comprise classical methods including Gauss elimination, iterative methods including any of the conjugate gradient methods, and decomposition methods, including eigenvalue, singular value, LDU, QR, and Cholesky decomposition. Each of the solved systems of equations have the form of equation (31). In equation (31), the term X_{y} is the product of the inverse of any coefficient matrix disclosed above, and a vector Y. The coefficient matrix may have been circulant, banded, or of dimensions smaller than the initial coefficient matrix. The vector Y may have been a rearranged, or transformed, vector. The matrix X_{A} is the product of an inverse coefficient matrix, and any of the matrices A disclosed above. The vectors X and S are unknown vectors. The matrix X_{A} is usually not required for the embodiment of FIG. 2(a). For the embodiment of FIG. 2(c), the matrix X_{A} is determined from pad columns used to form a circulant coefficient matrix. The matrix B comprises matrices Bₚ and B_{q}, which contain pad rows and modifying rows, respectively. The solution from each of the solved systems of equations is combined to form a solution for equation (1). For the pad rows and columns of the embodiments of FIGS. 2(b) and 2(c), the vector Sₚ can be determined by equation (32).

X=X_{y}+X_{A}S (31)

S=(I−BX_{A})⁻¹BX_{y}

Sₚ=−X_{Ap}⁻¹X_{y} (32)

For a coefficient matrix with a Toeplitz block Toeplitz structure, a different embodiment of the disclosed invention can be used for each Toeplitz level present in the coefficient matrix. The disclosed methods can also be applied to any Toeplitz sub-blocks.

Different devices 100 have different performance requirements with respect to memory storage, memory accesses, and calculation complexity. Depending on the device 100, different portions of the methods can be implemented on parallel computer architectures. When the disclosed methods are implemented on specific devices, method parameters such as the matrix Tₜ bandwidth m, number of pad and modified rows p and q, and choice of hardware architecture, must be selected for the specific device.

Further improvements in efficiency can be obtained if the sub-blocks of the coefficient matrix are large, and the inverse of the coefficient matrix T₀, T₀⁻¹, has elements whose magnitude decreases with increasing distance from the principal diagonal of each of the sub-blocks in the matrix T₀⁻¹. The second system solver 132 of FIG. 2(b) forms the vector X by zero padding the vector X₀ with rows that have zero value. The rows of the vector X that are set to zero are usually the rows at the beginning and end of each sub-vector of X. Rows with zero value are added at the beginning and the end of each sub-vector of the vector Y₀ to form a zero padded vector Y. The vector X is then divided into a vector X_{yr} and a vector Xᵣ. The vector X_{yr} is first calculated from equation (33), then additional selected row elements at the beginning, and at the end, of each sub-vector of the vector X_{yr} are set to zero to form a vector X_{yrp}. The vector X_{yrp} is the portion of the vector X that is approximately dependent on only the vector Y. The vector Xᵣ is then calculated from equation (34). The matrix Tₛ contains elements of either the matrix T₀, or the matrix T that correspond to nonzero elements in the vector X that are not part of the vector X_{yrp}. These are usually elements from the corner portions of the sub-blocks of the matrix T or matrix T₀ that are not pad rows or pad columns The elements in the vector Xᵣ are the additional selected row elements set to zero in the vector X_{yr} to form the vector X_{yrp}. The second system solver 132 solves equations (33) and (34) by any of the above disclosed methods. The system of equations (34) is usually much smaller than the system of equations (33). Even though the matrix T is approximately Toeplitz, the method of the embodiment disclosed in FIG. 2(a) can be used to obtain a solution to equations (33) and (34) due to the symmetry contained in the matrices T and Tₛ. This symmetry concerns the order of elements in different rows of a coefficient matrix. Generally, the methods of the embodiment of FIG. 2(a) can be applied when a coefficient matrix contains rows with elements that are in a reverse order of elements in another row of the coefficient matrix. Usually, the methods of the embodiment disclosed in FIG. 2(b) are used to solve equations (33) and (34). If the coefficient matrix comprises two Toeplitz levels, equations of the form of equations (33) and (34) can be formed twice, once for each level.

TX_{yr}=Y (33)

TₛXᵣ=Y₀−TX_{yrp} (34)

Many Toeplitz block Toeplitz matrices T are ill-conditioned. Pad rows and columns can be used to substantially improve the conditioning of the matrix T. If the solution X is not a sufficient approximation to the solution X₀, the iterator 135 of FIG. 2(b) uses equations (19) and (20) to calculate the solution X₀ by any methods known in the art. The updates require very few mathematical operations since most quantities have already been calculated for each of the updates. If the solution X is a sufficient approximation to the solution X₀, the solution X is the output of the iterator 135 as the solution X₀.

The system processor 134 calculates signals J from the solution X₀. Calculating the signals J can require both the solution X₀ and the signals J₀. Signals J can be calculated by any known method in the art, including calculating a sum of products comprising elements of the vector X₀ and the signals J₀. For some devices, there are no signals J₀. In these cases, the signals J comprise the vector X₀, or may actually be the vector X₀. If the vector X₀ and the signals J are both outputs of the solution component 130, the signals J also comprise the vector X₀. Both signals J and J₀ can be a plurality of signals, a single signal, a digital signal, or an analog signal.

The choice of hardware architecture depends on the performance, cost and power constraints of the particular device 100 on which the methods are implemented. The vector X_{y}, and the columns of the matrix X_{A}, of equation (31) can be calculated from the vector Yₜ and matrix Aₜ, on a SIMD type parallel computer architecture with the same instruction issued at the same time. The vector Yₜ and the matrix Tₜ can be from any of the above disclosed transformed systems of equations. The product of the matrix A and the vector S, and the products necessary to calculate the matrix Tₜ, can all be calculated with existing parallel computer architectures. The decomposition of the matrix Tₜ can also be calculated with existing parallel computer architectures.

The methods disclosed in the embodiments of FIGS. 2(a) and 2(c) are not limited to systems of equations having Toeplitz and block Toeplitz coefficient matrices. Both methods can be applied to any system of equations having a coefficient matrix that has rows with elements whose order are reversed with respect to the order of elements in another row of the coefficient matrix. The vectors of the system of equation can be separated into the sum of a symmetric vector, and a vector that has elements that are the negative of other elements in the vector. To eliminate the duplicate magnitudes in the vectors, the dimensions of the coefficient matrices is reduced. This increases solution efficiency at the expense of forming another systems of equations.

The disclosed methods can be efficiently implemented on circuits that are part of computer architectures that include, but are not limited to, a digital signal processor, a general microprocessor, an application specific integrated circuit, a field programmable gate array, and a central processing unit. These computer architectures are part of devices that require the solution of a system of equations with a coefficient matrix for their operation. The present invention may be embodied in the form of computer code implemented in tangible media such has floppy disks, read-only memory, compact disks, hard drives or other computer readable storage medium, wherein when the computer program code is loaded into, and executed by, a computer processor, where the computer processor becomes an apparatus for practicing the invention. When implemented on a computer processor, the computer program code segments configure the processor to create specific logic circuits.

The present invention is not intended to be limited to the details shown. Various modifications may be made in the details without departing from the scope of the invention. Other terms with the same or similar meaning to terms used in this disclosure can be used in place of those terms. The number and arrangement of the disclosed components can be varied. Different components of the device 100 and the solution component 130 can be combined, or separated into multiple components. All of the components of the device 100 can be combined into a single component. All of the sub-components of the solution component 130 can be combined into a single component. Sub-components of the solution component 130 can be combined with components of the device 100.

1. A device comprising digital circuits for processing digital signals, wherein said device is a component in one of an imaging device, a sensing device, a communications device, a control device, and a general signal processing device, said device further comprising:
a second system solver for calculating a solution X from signals Ss, wherein said signals Ss comprise elements of a matrix T₀ and a vector Y₀;
a system processor for calculating signals J from said solution X, wherein said solution X, said signals Ss, and said signals J represent at least one of: a beam pattern, physical characteristics of a target, transmitted speech, images and data, information to control a mechanical, electrical, chemical, or biological component, an image, and frames of speech and data; and
wherein said second system solver forms a transformed system of equations from said signals Ss, said transformed system of equations comprising a transformed coefficient matrix Tₜ.

2. A device as recited in claim 1, wherein said second system solver:
calculates a coefficient matrix T from said matrix T₀, wherein said coefficient matrix T comprises elements that are approximately equal to elements of said matrix T₀;
separates said coefficient matrix T into a sum of matrix products, wherein said sum of matrix products comprises circulant, or approximately circulant, matrices Cᵢ;
calculates said transformed coefficient matrix Tₜ from said matrices Cᵢ;
calculates a transformed vector Yₜ, wherein said transformed vector Yₜ is calculated from said vector Y₀; and
calculates a solution X from said transformed coefficient matrix Tₜ and said transformed vector Yₜ.

3. A device as recited in claim 1, wherein said second system solver:
calculates a block coefficient matrix T from said matrix T₀, wherein said block coefficient matrix T comprises elements that are approximately equal to elements of said matrix T₀, and wherein said matrix T₀ is a block matrix;
separates said block coefficient matrix T into a sum of matrix products, wherein said sum of matrix products comprises block circulant, or approximately block circulant, matrices Cᵢ;
calculates said transformed coefficient matrix Tₜ from said matrices Cᵢ, wherein said transformed coefficient matrix Tₜ is a block matrix;
calculates a block transformed vector Yₜ, wherein said block transformed vector Yₜ is calculated from said vector Y₀; and
calculates a block solution X from said block transformed coefficient matrix Tₜ and said block transformed vector Yₜ.

4. A device as recited in claim 1, wherein said second system solver calculates said solution X from a sum comprising a solution X_{pR}, wherein said solution X_{pR} is the solution to a system of equations with a block coefficient matrix T_{b}, said block coefficient matrix T_{b} being formed from portions of said matrix T₀, or from portions of a matrix T, wherein said matrix T is approximately equal to said matrix T₀.

5. A device as recited in claim 2, wherein said sum of matrix products further comprises diagonal matrices.

6. A device as recited in claim 2, wherein said device further comprises an iterator for calculating a solution X₀ from said solution X; and said system processor calculates signals J from said solution X₀.

7. A device as recited in claim 2, wherein said second system solver comprises parallel processing computer hardware architectures for calculating said solution X from said transformed coefficient matrix Tₜ and said transformed vector Yₜ.

8. A device as recited in claim 2, wherein said one of an imaging device, a sensing device, a communications device, a control device, and a general signal processing device further comprises:
a first input for generating signals Sin, said first input including at least one of the following devices: a sensor, a sensor array, a transducer, a transducer array, and hardwire connections;
a first processor for calculating said signals Ss from said signals Sin; and
an output.

9. A device as recited in claim 3, wherein said one of an imaging device, a sensing device, a communications device, a control device, and a general signal processing device further comprises:
a first input for generating signals Sin, said first input including at least one of the following devices: a sensor, a sensor array, a transducer, a transducer array, and hardwire connections;
a first processor for calculating said signals Ss from said signals Sin; and
an output.

10. A device as recited in claim 4, wherein said one of an imaging device, a sensing device, a communications device, a control device, and a general signal processing device further comprises:
a first input for generating signals Sin, said first input including at least one of the following devices: a sensor, a sensor array, a transducer, a transducer array, and hardwire connections;
a first processor for calculating said signals Ss from said signals Sin; and
an output.

11. A device comprising digital circuits for processing digital signals, wherein said device is a component in one of an imaging device, a sensing device, a communications device, a control device, and a general signal processing device, said device further comprising:
a first system solver for calculating a solution X₀ from signals Ss, wherein said signals Ss comprise elements of a coefficient matrix T₀ and a vector Y₀;
a system processor for calculating signals J from said solution X₀, wherein said solution X₀, said signals Ss, and said signals J represent at least one of: a beam pattern, physical characteristics of a target, transmitted speech, images and data, information to control a mechanical, electrical, chemical, or biological component, an image, and frames of speech and data; and
wherein said first system solver calculates a symmetric vector and an asymmetric vector from said vector Y₀.

12. A device as recited in claim 11, wherein said first system solver calculates a symmetric coefficient matrix and a skew-symmetric coefficient matrix from said coefficient matrix T₀.

13. A device as recited in claim 11, wherein said first system solver calculates a symmetric coefficient matrix comprising symmetric sub-blocks, and a skew-symmetric coefficient matrix comprising skew-symmetric sub-blocks from said coefficient matrix T₀.

14. A device as recited in claim 12, wherein said one of an imaging device, a sensing device, a communications device, a control device, and a general signal processing device further comprises:
a first input for generating signals Sin, said first input including at least one of the following devices: a sensor, a sensor array, a transducer, a transducer array, and hardwire connections;
a first processor for calculating said signals Ss from said signals Sin; and
an output.

15. A device as recited in claim 13, wherein said one of an imaging device, a sensing device, a communications device, a control device, and a general signal processing device further comprise:
a first input for generating signals Sin, said first input including at least one of the following devices: a sensor, a sensor array, a transducer, a transducer array, and hardwire connections;
a first processor for calculating said signals Ss from said signals Sin; and
an output.

16. A device comprising digital circuits for processing digital signals, wherein said device is a component in one of an imaging device, a sensing device, a communications device, a control device, and a general signal processing device, said device further comprising:
a third system solver for calculating a solution X₀ from signals Ss, wherein said signals Ss comprise elements of a coefficient matrix T₀ and a vector Y₀;
a system processor for calculating signals J from said solution X₀, wherein said solution X₀, said signals Ss, and said signals J represent at least one of: a beam pattern, physical characteristics of a target, transmitted speech, images and data, information to control a mechanical, electrical, chemical, or biological component, an image, and frames of speech and data; and
wherein said third system solver forms at least one circulant coefficient matrix from said signals Ss.

17. A device as recited in claim 16, wherein said third system solver calculates at least one of a symmetric coefficient matrix and a skew-symmetric coefficient matrix from said coefficient matrix T₀.

18. A device as recited in claim 16, wherein said third system solver calculates at least one of a symmetric coefficient matrix comprising symmetric sub-blocks, and a skew-symmetric coefficient matrix comprising skew-symmetric sub-blocks from said coefficient matrix T₀.

19. A device as recited in claim 17, wherein said one of an imaging device, a sensing device, a communications device, a control device, and a general signal processing device further comprises:
a first input for generating signals Sin, said first input including at least one of the following devices: a sensor, a sensor array, a transducer, a transducer array, and hardwire connections;
a first processor for calculating said signals Ss from said signals Sin; and
an output.

20. A device as recited in claim 18, wherein said one of an imaging device, a sensing device, a communications device, a control device, and a general signal processing device further comprises:
a first input for generating signals Sin, said first input including at least one of the following devices: a sensor, a sensor array, a transducer, a transducer array, and hardwire connections;
a first processor for calculating said signals Ss from said signals Sin; and
an output.
